(19) United States
(12) Patent Application Publication
(10) Pub. No.: US 2004/0000525 A1
(43) Pub. Date: Jan. 1, 2004

(54) System and method for reducing swimming pool energy consumption

(76) Inventor: Ike W. Hornsby, Bakersfield, CA (US)

Correspondence Address: James M. Duncan, Klein, DeNatale, Goldner, Cooper,, Rosenlieb & Kimball, LLP, P.O. Box 11172, Bakersfield, CA, 93389-1172, US

(21) Appl. No.: 10/608,308

(22) Filed: Jun. 26, 2003

Related U.S. Application Data
(63) Continuation-in-part of application No. 09/909,491, filed on Jul. 19, 2001, now abandoned.
(63) Continuation-in-part of application No. 10/188,508, filed on Jul. 3, 2002.

(51) Int. Cl. C02F 1/40

(52) U.S. Cl. 210/776; 210/130; 210/141; 210/169; 210/416.2; 210/424; 15/1.7

(57) ABSTRACT

A system and method for reducing the energy consumption of a swimming pool cleaning system is disclosed. The system operates the skimmer for a first predetermined time period inputted into a programmable controller. At the conclusion of this time period, the programmable controller activates an actuator which causes a diverter valve or in-line valve to isolate and selectively operate a suction vacuum for a second predetermined time period. Isolating and selectively operating the suction vacuum from the skimmer allows the centrifugal pump to be driven by a motor in low speed mode to be used all of the time for skimming and cleaning operations, thereby greatly reducing energy consumption.

### CROSS-REFERENCE TO RELATED APPLICATIONS

This is a continuation-in-part of U.S. application Ser. No. 09/909,491, filed on Jul. 19, 2001, and U.S. application Ser. No. 10/188,508, filed on Jul. 3, 2002, to which the inventor claims domestic priority, and which are incorporated by reference herein.

### BACKGROUND OF THE INVENTION

The present invention relates to a system and method for filtering swimming pool water and cleaning a swimming pool. More particularly, this invention relates to a system and method which reduces energy consumption by selective application of the filter pump motor to either skimming operations or vacuuming operations, or a combination of each. The selective application of the motor to the vacuuming operation in isolation allows almost continuous use of a lower speed motor resulting in substantial decreases in energy consumption.

It is known that operating a swimming pool can require a substantial amount of energy. The typical residential swimming pool installation has a filtering unit through which daily flows the total volume of water in the pool. The filtering unit is normally operated for several hours per day and is used in conjunction with chemical treatment, such as chlorination, to maintain the clarity and cleanliness of the water. Water is drawn into the filtering unit and pumped through the filtering unit with a self-priming, single suction, centrifugal type pump. A pump motor is attached directly to the seal plate of the pump. The pump motor is an open-drip proof type, capacitor start/induction run design or capacitor start/capacitor run design. Perhaps the most commonly used motor is a single phase, 60 HZ, 3450 RPM motor operating on either a 115 VAC or 230 VAC circuit.

Water may be drawn into the pump inlet from several sources. The water may come from the pool skimmer, which cleans floating debris from the surface of the water. The water may also come from a submerged drain in either the pool or a spa. The water may also come from a suction vacuum which, powered by water drawn through the unit from the pump suction, travels over the submerged surfaces of the swimming pool and collects debris such as leaves, dirt, and twigs which may accumulate at the bottom and side walls of the pool. The larger debris collected by the suction vacuum, including leaves and twigs, are typically accumulated in an in-line collection basket upstream of the pump suction. Suspended debris, such as suspended dirt and silt, is collected in the filtering medium of the filtering unit.

Another type of automatic vacuuming device, the pressure cleaner, may also be used instead of the suction vacuum. The pressure cleaner is connected to a return line from the filtering unit. The pressure vacuum is powered by positive pressure, drawing debris into a filter bag by venturi action. In older installations the pressure cleaner may employ a booster pump driven by a second motor to provide the necessary pump pressure to drive the device.

It has long been recognized that energy consumption by swimming pools can be substantial and efforts have been made to develop equipment and procedures which increase the efficiency of the pool cleaning system and decrease the required energy demand. In this regard, U.S. Pat. No. 4,545,906 discloses a pump motor having two sets of stator windings allowing the motor to run at nominal running speeds of either 3500 RPM or 1750 RPM. The '906 patent discloses that for one installation, the nominal motor speed of 3500 RPM produces a flow rate of 45 gallons per minute with energy consumption of 1080 watts, while the nominal motor speed of 1750 RPM produces a flow rate of 21 gallons per minute with energy consumption of 200 watts. Thus, for the system analyzed, the lower running speed resulted in a flow rate approximately half of the flow rate at the higher speed, but the energy consumption for the lower running speed was only one-fifth of the energy consumption for the higher speed. These results show that substantial energy can be saved if the centrifugal pump can be operated at a reduced pump motor speed.

The invention disclosed in the '906 patent contemplates using the motor at both the high speed and low speed depending upon the needs of the system. For example, the patent discloses that the high motor speed is required for system priming, periods of heavy pool use or for clean-up after a storm and, of particular relevance to the system and method disclosed herein, for high speed circulation rates required for vacuuming operations. The low speed, discloses the patent, is sufficient during other times to prevent the pool from becoming stagnant with the resulting growth of algae. The speeds on the device may be manually selected. Optionally, a timer may be used to automatically switch the motor speed for predetermined periods of operation.

However, because an automatic suction vacuum is typically run several hours a day, the system disclosed in the '906 patent continues to have substantial periods of time each day during which the high speed function of the two-speed motor is required, resulting in substantial energy consumption. Many other systems, because of the added expense of the two-speed motor and second timer required by the system disclosed in the '906 patent, continue to operate entirely on high speed motors. Therefore, notwithstanding the potential energy savings available with a low speed motor, existing swimming pool systems continue to consume substantial amounts of energy. However, the disclosed system and method provide a means for running a swimming pool cleaning system with a low speed motor during almost all periods of operation.

### SUMMARY OF THE INVENTION

The present invention is directed to a system and method for reducing swimming pool energy consumption, meeting the needs identified above.

The disclosed system comprises a filter system for cleaning a swimming pool, the pool having walls and water contained within the walls, the filter system being of the type in which a water circulation path is provided, the path including the pump suction inlet from the pool, an outlet for discharging water into the pool, a centrifugal pump, and a filter between the inlet and outlet. The inlet has a first source and a second source, the first source comprising a skimmer for receiving water and debris skimmed from the surface of the water of the pool. The second source comprises a suction vacuum for receiving water and debris from the walls of the pool. The system further comprises valve means for switching the inlet from the first source to the second source and from the second source back to the first source. Actuating means are coupled to the valve means, the actuating means having a first and second position. In the first position, the actuating means manipulates the valve means to receive water from the first source. In the second position the actuating means manipulates the valve means to receive water from the second source. The system further comprises programmable input means for controlling the actuating means. A motor is coupled to the centrifugal pump, the motor having a running speed of less than 3450 revolutions per minute. A motor having a rated speed of 1725 revolutions per minute may also be used.

In another embodiment, the system comprises the same filter system for cleaning a swimming pool as in the above embodiment. However in this embodiment the valve means switches the inlet from both the first and second source to primarily the second source, with some bypass allowed from the first source.

Methods of reducing swimming pool energy consumption are also disclosed utilizing the embodiments disclosed herein.

These and other features, aspects, and advantages of the present invention will become better understood with regard to the following description, appended claims, and accompanying drawings.

### BRIEF DESCRIPTION OF THE DRAWINGS

FIG. 1 is a diagram showing the disclosed system for use with a suction vacuum.

FIG. 2 is a diagram showing an alternative embodiment of the disclosed system for use with a suction vacuum.

FIG. 3 is a diagram showing an alternative embodiment of the disclosed system for use with a suction vacuum.

FIG. 4 shows a perspective view of an actuated in-line valve for use in the alternative embodiment of FIG. 3.

FIG. 5 shows a side view of the actuated in-line valve for use in the alternative embodiment of FIG. 3.

FIG. 6 shows a view facing the inlet of the actuated in-line valve for use in the alternative embodiment of FIG. 3.

FIG. 7 shows a top view of the actuated in-line valve for use in the alternative embodiment of FIG. 3.

FIG. 8 shows a sectional view along line 8-8 of FIG. 7.

FIG. 9A shows a sectional view along line 9-9 of FIG. 7, when the actuated in-line valve is in a first open position.

FIG. 9B shows a sectional view along line 9-9 of FIG. 7, when the actuated in-line valve is in a second closed position.

### DETAILED DESCRIPTION OF THE EMBODIMENTS

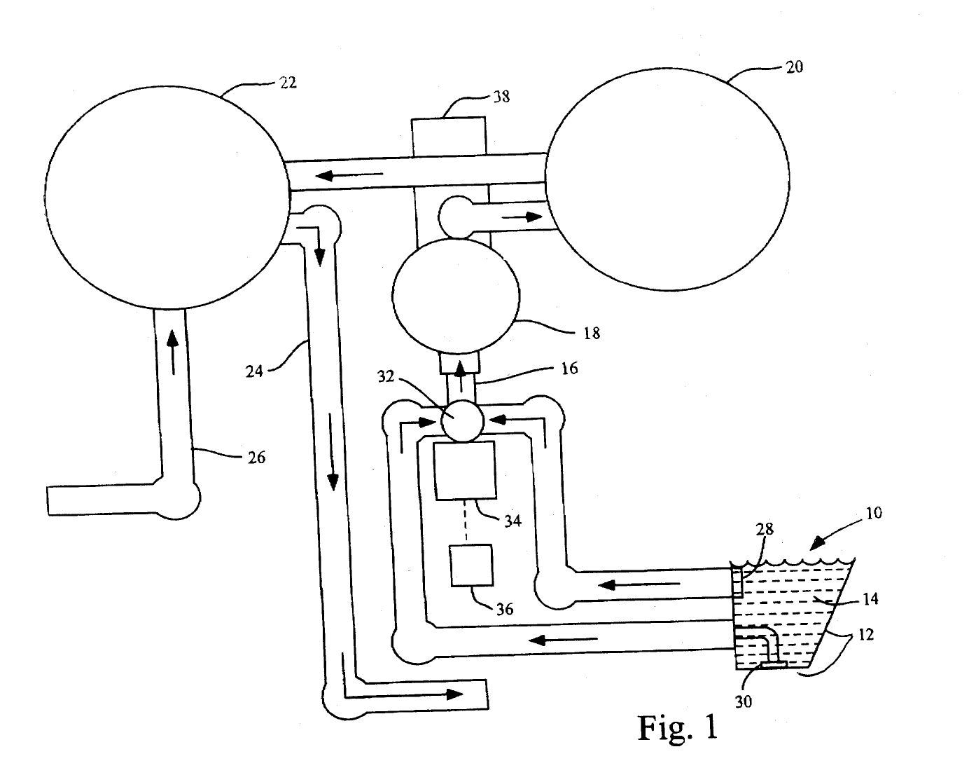

Referring now specifically to the drawings, FIG. 1 shows a diagram of the disclosed system for use with a suction vacuum system. The schematic shows a pool 10 having walls 12 and water 14 contained within the walls. The filtering system provides a water circulation path in which water 14 is taken from the pool. The path including an inlet 16 to the suction side of a single-stage centrifugal pump 18, which pumps water taken from the pool into a filtering unit 20. Filtered water exits the filtering unit 20, and may enter a heater 22 and exit the heater into a return line 24 to the pool. If heater 22 is used, heating fuel is provided to the heater through fuel line 26. Alternatively, heater 22 may be bypassed and filtered water may enter the return line 24 directly from the filtering unit 20.

The inlet 16 has two different sources from which it may receive water 14 from the pool 10. The first source is from the skimmer 28. The second source is from suction vacuum 30. Skimmer 28 includes a well which extends several inches below the surface of water 14, and typically contains a basket for collecting leaves, sticks and other debris floating on the surface of the water 14. It is to be appreciated that many pools also have a drain typically located at the bottom of the pool 10, the drain connected to a suction line common with the skimmer 28, so the term skimmer 28 used herein may also include such a drain. Alternatively, if the drain were operated on an independent line from the skimmer 28, the drain would be a third source to inlet 16. A three-way diverter valve could then be used, which would isolate each source to the inlet 16.

Suction vacuum 30 operates off of suction from pump 18, and collects leaves, sticks, dirt, silt and other debris which sink and/or coat the walls 12 of the pool. Such suction vacuums are manufactured by, among others, Polaris Pool Systems, Inc. of Vista, Calif., and have been described in U.S. Pat. Nos. 3,803,658; 4,023,227; 4,133,068; 4,208,752; 4,351,077; 4,642,833; 25 4,742,593; 4,761,848; 4,769,867; 4,807,318; 5,265,297; 5,315,728; 5,450,645; 5,634,229 and 6,112,354.

Valve means 32, such as a diverter valve are located upstream of inlet 16 for switching from skimmer 28 to the suction vacuum 30. An acceptable diverter valve for the valve means 32 is a Jandy Never Lube Valve, Model No. 4715. Actuating means 34 are directly coupled to the valve means 32. An acceptable actuator for the actuating means 34 is an Autospa Valve Actuator, Model #VA-100E, manufactured by Chardonnay Corporation of Newport Beach, Calif. The actuating means 34 operates valve means 32 so that the source of water to inlet 16 is either the skimmer 28 or the suction vacuum 30. The actuating means 34 is controlled by programmable input means 36, which may be a simple timer, such as a Model #T104R manufactured by Intermatic Timer or a programmable digital device. The programmable input means 36 is in addition to the timer or controller used for activating the motor 38. If a three-way diverter valve is used as discussed above, the Model #VA-100E actuator or other appropriate actuating means may be modified to position the valve to allow flow from the desired source.

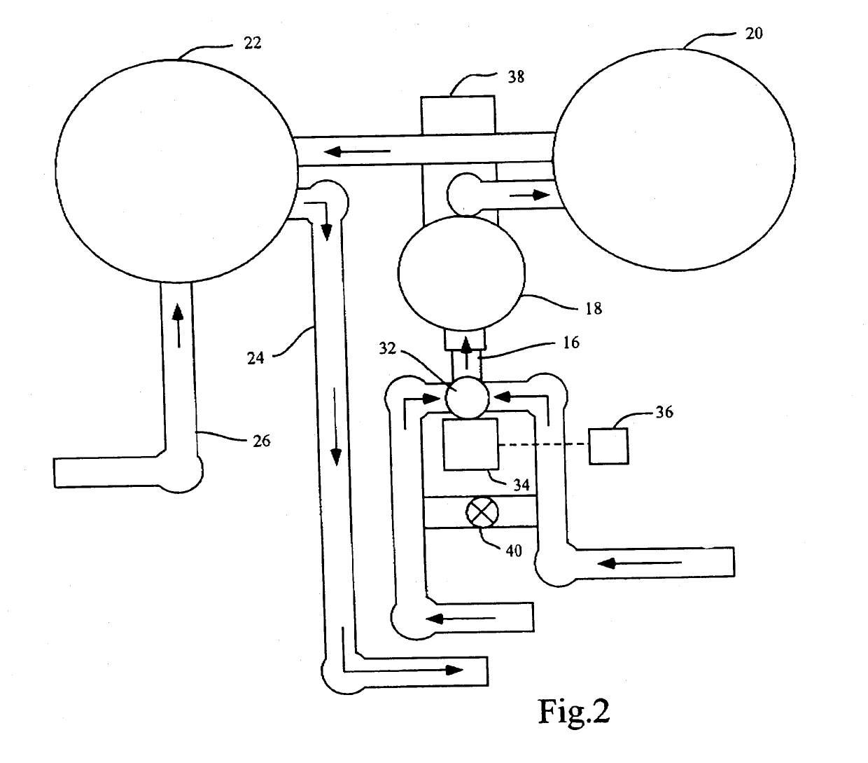

A motor 38 is coupled to pump 18. In order to realize reduced energy consumption from a system which uses a motor with a speed of 3450 RPM, a motor capable of running at a lower speed must be utilized. Acceptable motors for use as motor 38 are manufactured by A. O. Smith Corporation, distributed by Sta-Rite Industries of Waterford, Wis., and have dual speed capability with speeds of 3450 RPM and 1725 RPM. The most efficient types of motors are capacitor start/capacitor run design. Depending upon the suction requirements of suction vacuum 30, it may be desirable, while motor 38 is running at a lower speed, to allow partial suction of the skimmer 28 at the same time suction vacuum 30 is in operation. As shown in FIG. 2, use of bypass valve 40 allows some water 14 from skimmer 28 to enter inlet 16 while suction vacuum 30 is in operation.

The disclosed system greatly reduces the amount of energy consumed in operating the pool cleaning system. Existing pool cleaning systems simultaneously pull suction on both a skimmer (or drain) and a suction vacuum. As recognized in U.S. Pat. No. 4,545,906, the higher motor speed is required to simultaneously operate a skimmer and a suction cleaning system. In order to completely clean the surface area of the pool walls, it is necessary to run the suction vacuum several hours per day, greatly reducing the amount of time when the system may be operated at the lower motor speed. However, the disclosed system overcomes this limitation by isolating and selectively operating the skimmer and the suction vacuum. If these devices are isolated and run independently of one another, it is possible to utilize a lower running speed almost all of the time the pump is running, resulting in substantial energy reduction.

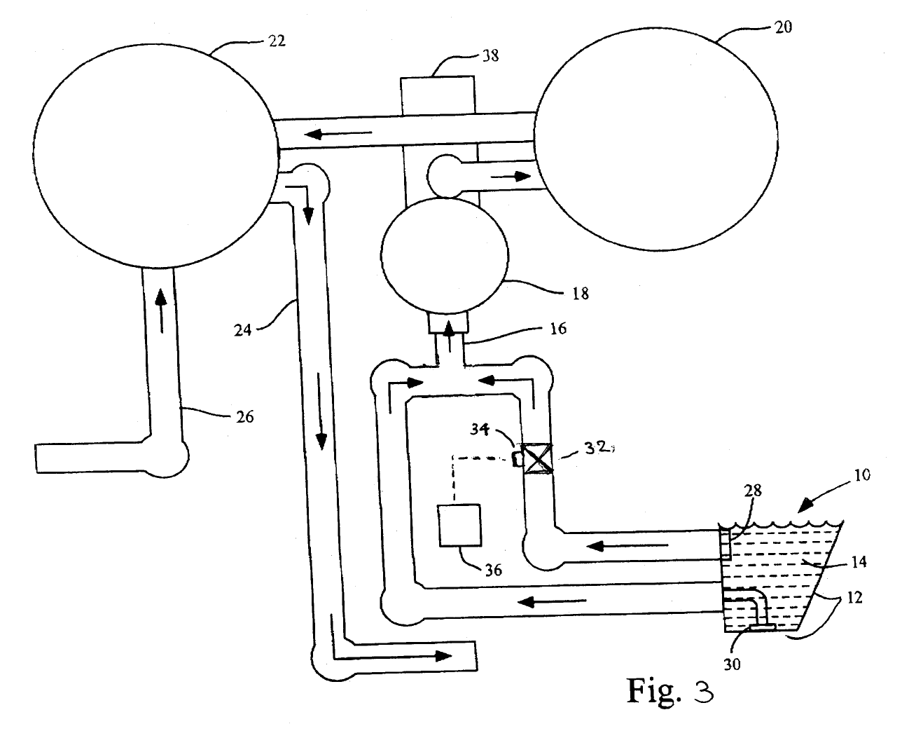

As shown in FIG. 3, an alternative embodiment of the disclosed system utilizes an in-line valve for valve means 32, as opposed to the diverter valve discussed above. This embodiment recognizes that while it is necessary that the suction vacuum 30 be largely isolated and run independently from the skimmer 28, because of the difference in the hydraulic requirements for the skimmer, the skimmer does not necessarily have to be isolated from the vacuum for efficient performance. When the in-line valve is used, it is placed on the line coming from skimmer 28 to inlet 16. In this configuration, when the in-line valve is open, the source of water to inlet 16 is both the skimmer 28 and the suction vacuum 30. However, because the line from the skimmer 28 is usually shorter and of larger diameter than the line or lines from the suction vacuum 30, the path of least resistance is for flow from the skimmer. Therefore, when the in-line valve is open, the source of water will be largely from the skimmer 28 and little water will come from suction vacuum 30. However, when the in-line valve is closed, the source of water to inlet 16 will be suction vacuum 30. Therefore, this embodiment of the system functions essentially the same as the embodiment utilizing the diverter valve discussed above.

Like the diverter valve, the in-line valve is equipped with actuating means 34. Depending upon the type of in-line valve utilized, the actuating means 34 for the in-line valve may employ a solenoid actuator to open or close the valve.

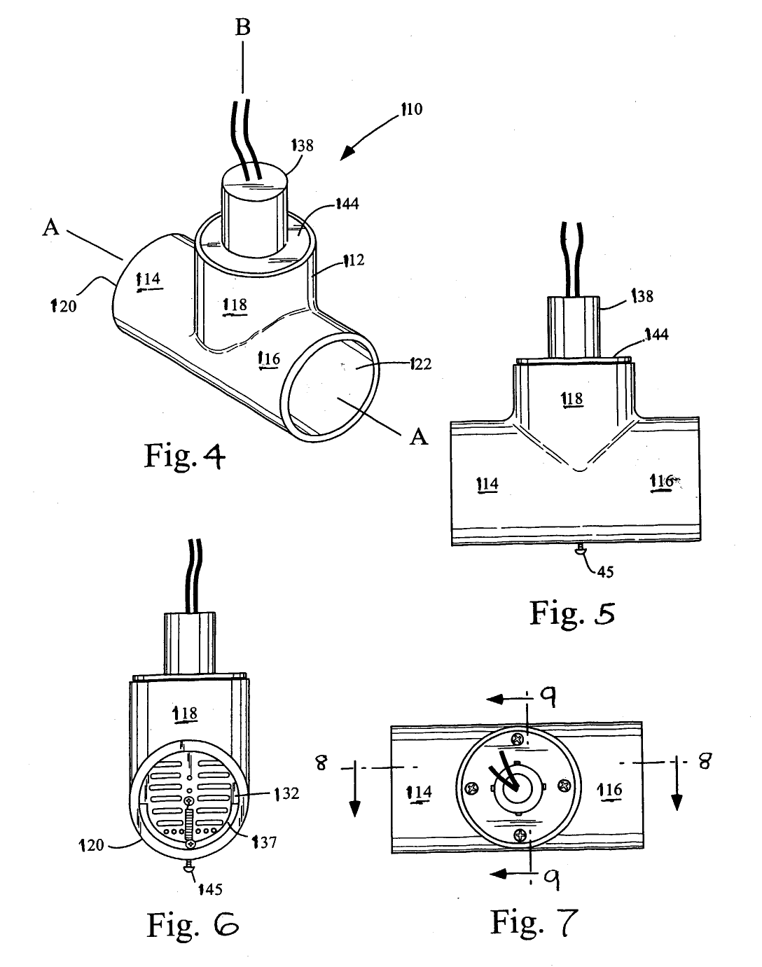

One type of in-line valve which may be used as the valve means 32 is shown in FIGS. 4 through 9. This type of valve eliminates the need for any bypass valve 40, because the in-line valve itself allows for bypass. As discussed in detail below, the actuating means 34 for this valve is an integral part of the valve.

FIGS. 4 through 7 show the exterior components of the actuated in-line valve 110. The valve 110 generally comprises a tee-shaped valve body 112, where the body 112 has a first axis A defined by a first leg 114 and a second leg 116 opposite the first leg. A second axis B is defined by a third leg 118, where the third leg is perpendicular to the first leg 14 and the second leg 116 and the second axis B is perpendicular to the first axis A. An inlet 120 is formed by the first leg 114 of the tee and an outlet 122 is formed by the second leg 116 of the tee. In its most simple form, valve body 112 may be formed from a PVC Tee. For application in a residential pool environment, a PVC Tee in a size ranging from 2 inches to 3 inches may be used.

A stationary plate 124 is attached within the valve body 112 with attachment means, such as plate supports 126. Plate supports 126 may be glued or otherwise attached within the valve body 112, or the plate supports may be formed as an integral part of the valve body 112 if the valve body is cast or manufactured by an injection mold process.

The stationary plate 124 has a first face 128, where the first face has a first plurality of openings 130. The stationary plate 124 is attached within the valve body 112 such that the first face 128 is perpendicular to the first axis A and parallel to the second axis B. A sliding plate 132 is slideably attached within the valve body 112 such that the sliding plate 132 is parallel to and abutting the stationary plate 124. The sliding plate 132 has a second face 134, where the second face has a second plurality of openings 136. The sliding plate 132 also has a top end 133 and a bottom end 135. The sliding plate 132 is guided and laterally retained by plate guides 137, which may be glued or otherwise attached within the valve body 112, or the plate guides may be formed as an integral part of the valve body if the valve body is cast or manufactured by an injection mold process.

The sliding plate 132 is slideable in the direction of the second axis B. A flow area is created by the positioning of the second plurality of openings 136 of the second face 134 with respect to the openings 130 of the first face 128. Actuating means 32′, such as a solenoid 138 combined with an operating rod 140 are attached to the sliding plate 132 for sliding the sliding plate in a direction parallel to the second axis B. The operating rod 140 may be bonded to the plunger of the solenoid using known adhesives, or an integral plunger/operating rod may be implemented. The solenoid 138 may be attached to cap 144, which acts as sealing means for sealing off the third leg 118.

The actuating means are activated by an electrical current, such that the flow area is decreased when the actuating means is activated. An acceptable solenoid 138 is model number 701-24AB2C available from Industrial Plastic Valves Company of Carson City, Nev. This solenoid uses a series 701 solenoid coil, operating at 24 VAC. Many 24 VAC solenoids are acceptable, including those which are sold off-the-shelf at many facilities for use with automatic irrigation and sprinkler systems.

It is to be appreciated that the flow area of the disclosed valve is adjusted by the relative position of the sliding plate 132 with respect to the stationary plate 124, because adjusting the relative position of the sliding plate with respect to the stationary plate changes the respective arrangements of the first plurality of openings 130 of the first face 128 of the stationary plate 124 with respect to the second plurality of openings 136 of the second face 134. The more the openings 136 of the sliding plate 132 line up with the openings 130 of the stationary plate 124, the larger the flow area.

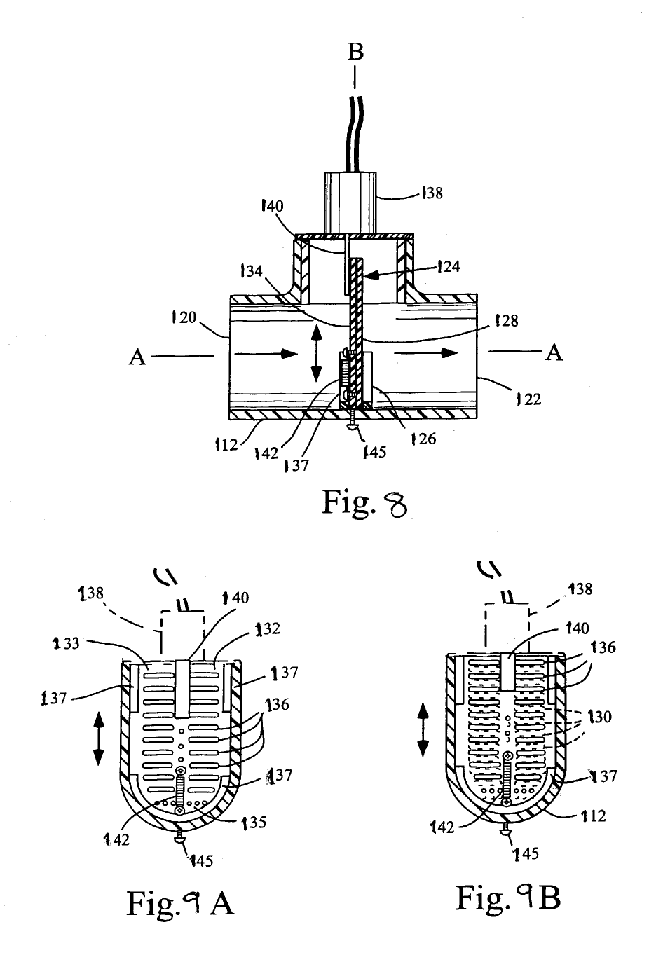

In one embodiment of the in-line valve 110, the dimensions of the stationary plate 124 may be equivalent to the dimensions of the sliding plate 132, and the pattern of the first plurality of openings 130 of the first face 128 may match the pattern of the second plurality of openings 136 of the second face 134, as shown in FIGS. 6, 9A and 9B. In these figures, the first plurality of openings 130 and the second plurality of openings 136 may comprise a series of slots and holes. It has been found for a 2″ valve body that a maximum flow area of 1.76 square inches works well. It is to be appreciated that for the valve shown in FIGS. 6, 9A and 9B, a very small movement of sliding plate 132 along axis B results in the valve being either fully open or fully closed. Such minimal travel is desirable because the plunger of solenoid 138 generally has limited travel, approximately ⅛″ to ¼″.

Biasing means, such as a spring 142 are attached to the sliding plate 132 and the valve body 112. The biasing means maintain the flow area at a maximum size when the actuating means is not activated, where the biasing means retains the sliding plate in a first open position along the second axis. In this first open position of the sliding plate 132, the second plurality of openings 136 of the second face 134 are in facing relation with the first plurality of openings 130 of the first face 128. When the actuating means are activated, the sliding plate 132 may be placed in a second closed position wherein the second plurality of openings 136 of the second face 134 are in facing relation to portions of the first face 128 having no openings. Therefore, the sliding plate 132 is retained in the first open position except when the actuating means are activated. As shown in FIG. 8, an adjustment screw 145 may be inserted through valve body 112, so that the tip of the adjustment screw engages sliding plate 132. The adjustment screw allows the user to manually adjust the amount of bypass.

Unlike most other valves, the disclosed actuated in-line valve 110 is designed so that even in the fully closed position, a certain amount of bypass is allowed through the valve. The in-line valve 110 is intended to allow a bypass of approximately 20% even when the valve is in the “closed position.” Because solenoid 138 must be energized for the valve 110 to be in a “closed” position, the bypassing liquid serves to cool the solenoid.

A method of reducing swimming pool energy consumption comprises the steps of placing the above system into operation. A pool filtering system is configured so that the pump inlet 16 may receive pool water 14 and floating debris from a first source at the skimmer 28 (or drain) or from a second source at a suction vacuum 30. The next step is to switch inlet 16 from receiving water 14 from the first source at the skimmer 28 so that inlet 16 receives water 14 from the second source at the suction vacuum 30 by using valve means 32. Valve means 32 is switched by actuating means 34 which is directly coupled to the valve means. The actuating means 34 has a first and second position, where the first position sets the valve means 32 so that inlet 16 receives water from the skimmer 28 and the second position sets the valve means so that inlet 16 receives water from the suction vacuum 30. The next step is to control actuating means 34 with programmable input means 36, so that the inlet 16 is switched from the skimmer 28 to the suction vacuum 30 for a time period entered into the programmable input means 36. At the end of this time period, the programmable input means 36 causes the actuating means 34 to manipulate valve means 32 so that inlet 16 receives water once again from the skimmer 28. The final step is drive centrifugal pump 18 with a motor 38 coupled to the pump, where the motor has a running speed of less than 3450 RPM, and preferably 1725 RPM.

It is also to be appreciated that many pools include spas which are maintained by the same filtering system. Spas typically employ high pressure jets which require either an independent motor and booster pump, or require the centrifugal pump 18 connected to the filtering unit 20 be driven at a higher speed. The two-speed motor described above may be used for this purpose, the higher speed available by manual control.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A system for reducing swimming pool energy consumption comprising:
(a) a filter system for cleaning a pool, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) the inlet having a first source and a second source, the first source comprising a skimmer for receiving water and debris skimmed from the surface of the water and the second source comprising a suction vacuum for receiving water and debris from the walls of the pool;
(c) valve means for switching the inlet from the first source to the second source and from the second source to the first source;
(d) actuating means coupled to said valve means, the actuating means having a first and second position, the first position manipulating the valve means to receive water from the first source and the second position manipulating the valve means to receive water from the second source;
(e) programmable input means for controlling the actuating means;
(f) a motor coupled to the centrifugal pump, the motor having a speed of less than 3450 revolutions per minute; and
(g) bypass means for allowing the inlet to receive water from the first source when said actuating means is in the second position.

2. The system of claim 1 wherein the motor has a speed of approximately 1725 revolutions per minute.

3. The system of claim 1 wherein the valve means is a diverter valve.

4. The system of claim 1 wherein the bypass means comprises a bypass valve connected between the first source and second source.

5. The system of claim 1 wherein the programmable input means is a timer of the variety which energizes an electrical circuit for a preset time period each day.

6. The system of claim 5 wherein the timer causes the actuating means to switch from the first position to the second position.

7. A system for reducing swimming pool energy consumption comprising:
(a) a filter system for cleaning a pool, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) the inlet having a first source and a second source, the first source comprising a skimmer for receiving water and debris skimmed from the surface of the water and the second source comprising a suction vacuum for receiving water and debris from the walls of the pool;
(c) valve means for switching the inlet to receive water from the first source and the second source to receive water primarily from the second source;
(d) actuating means coupled to said valve means, the actuating means having a first and second position, the first position manipulating the valve means for the inlet to receive water from the first source and the second source, and the second position manipulating the valve means for the inlet to receive water primarily from the second source;
(e) programmable input means for controlling the actuating means; and
(f) a motor coupled to the centrifugal pump, the motor having a speed of less than 3450 revolutions per minute.

8. The system of claim 7 wherein the valve means is an in-line valve.

9. The system of claim 8 wherein the in-line valve comprises:
(a) a tee-shaped valve body, the body having a first axis defined by a first leg and a second leg opposite the first leg and a second axis defined by a third leg, the third leg perpendicular to the first leg and second leg and the second axis perpendicular to the first axis;
(b) an inlet formed by the first leg of the tee and an outlet formed by the second leg of the tee;
(c) a stationary plate having a first face, the first face having a first plurality of openings, the stationary plate attached within the valve body with attachment means such that the first face is perpendicular to the first axis and parallel to the second axis;
(d) a sliding plate having a second face, the second face having a second plurality of openings, the sliding plate slideably attached within the valve body such that the sliding plate is parallel to and abutting the stationary plate, and slideable in the direction of the second axis, a flow area created by the positioning of the second plurality of openings with respect to the first plurality of openings, the flow area having a maximum size and a minimum size;
(e) wherein the actuating means is attached to the sliding plate for sliding the sliding plate in a direction parallel to the second axis, the actuating means activated by an electrical current, wherein the flow area is having the minimum size when the actuating means is activated;
(f) biasing means attached to the sliding plate, said biasing means maintaining the flow area at the maximum size when the actuating means is not activated; and
(g) sealing means for sealing the third leg.

10. The system of claim 9 wherein the actuating means comprises a solenoid, the solenoid having a solenoid coil and a solenoid plunger, and an operating rod having a first end connected to the plunger and a second end attached to the sliding plate.

11. The system of claim 9 wherein the motor has a speed of approximately 1725 revolutions per minute.

12. A method of reducing swimming pool energy consumption comprising the steps of:
(a) cleaning water from a pool with a filter system, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) configuring the inlet to receive water from a first source and a second source, the first source comprising a skimmer for taking water and debris skimmed from the surface of the water and the second source comprising a suction cleaner for taking water and debris from the walls of the pool;
(c) using valve means, switching the inlet from receiving water from both the first source and the second source to receiving water primarily the second source, said valve means being switched by actuating means coupled to the valve means, the actuating means having a first and second position, the first position setting the valve means to receive water from the first source and the second source and the second position setting the valve means to receive water primarily from the second source;
(d) controlling the actuating means with programmable input means, so that the actuating means is switched from the first position to the second position for a time period entered into the programmable input means and following said time period the actuating means is switched from the second position to the first position; and
(e) driving the centrifugal pump with a motor coupled to the centrifugal pump, the motor having a speed of less than 3450 revolutions per minute.

13. The method of claim 12, the motor having a speed of 1725 revolutions per minute.
